(19) United States
(12) Patent Application Publication
(10) Pub. No.: US 2018/0345236 A1
(43) Pub. Date: Dec. 6, 2018

(54) Reaction Vessel, Manufacturing System of Substance Using the Same, and Manufacturing Method

(71) Applicant: Hitachi, Ltd., Tokyo (JP)

(72) Inventors: Toshimitsu NOGUCHI, Tokyo (JP); Takuya KAMBAYASHI, Tokyo (JP); Shinichi TANIGUCHI, Tokyo (JP)

(21) Appl. No.: 15/869,477

(22) Filed: Jan. 12, 2018

(30) Foreign Application Priority Data
Jun. 1, 2017 (JP) 2017-109119

(51) Int. Cl. B01F 15/00; B01F 7/20

(52) U.S. Cl. CPC B01F 15/00272; B01F 15/00253; B01F 15/00285; B01F 7/20; B01F 15/00389; B01F 15/00396; B01F 2215/0034; B01F 15/00175; B01F 15/00214; B01F 15/0022; B01F 15/00227; B01F 2215/0036; B01F 15/00162

(57) ABSTRACT

A reaction vessel includes a vessel that accommodates a substance, a stirring device that stirs the substance, and a bypass that causes the substance to circulate outside the vessel, in which one end and the other end of the bypass are connected to the vessel in a position at which the substance circulates in the bypass when the substance is stirred by the stirring device.

### BACKGROUND OF THE INVENTION

### Field of the Invention

The present invention relates to a reaction vessel, a manufacturing system of a substance using the same, and a manufacturing method.

### Background Art

In the related art, in a manufacturing process in which there is a need to measure or observe a component concentration, a state, a shape, or the like of a substance within a vessel, the substance is extracted from the vessel by using a spuit, a syringe, a tube, or the like, and the measurement or the observation is performed.

As an example of the related art, JP-A-2009-294002 discloses an apparatus in which a bypass and a circulation pump are disposed in a stirring tank, a specimen is sent to a measurement portion through the bypass, a state of the specimen is measured by an analysis device, and the specimen is returned to the stirring tank. JP-A-2009-294002 discloses that “a stirrer with a heater that uniformly stirs a solution including a trace substance and causes a specific reaction to progress in the solution, a measurement cell that is capable of maintaining uniformity of the solution by including a flow-in port and a flow-out port of the solution, and a storing portion of the solution between the flow-in port and the flow-out port and includes a light-receiving window for irradiating the solution within the storing portion with an incident X-ray which is emitted from an X-ray source, a 7-element SDD that is capable of detecting the trace substance in the solution on the spot by receiving a fluorescent X-ray which is emitted by the solution irradiated with the X-ray through the light-receiving window, a flow path that communicates between the stirrer with the heater and the measurement cell, and a liquid delivery pump that causes the solution to circulate between the stirrer with the heater and the measurement cell by being interposed in the middle of the flow path are included” (abstract).

### SUMMARY OF THE INVENTION

As in the related art, in the extracting of the substance by using the spuit, the syringe, or the like, a continuous measurement is difficult. If the substance is extracted in a state where a lid of the vessel is open, there is a possibility that gas is released outside or air is mixed inside, thereby, the component is changed within the vessel, or there is a risk that dirt or bacteria is mixed and contaminated from the outside. In the apparatus disclosed in JP-A-2009-294002, the circulation pump becomes necessary in the bypass for sampling. In this case, not only a structure becomes complicated, but also a risk of failure of a mechanical movable portion such as the circulation pump occurs.

An object of the present invention is to provide a reaction vessel that is capable of continuously measuring or observing a component, a state, or the like of a substance within a reaction vessel on the spot.

In order to solve the above problems, according to an aspect of the present invention, there is provided a reaction vessel including a vessel that accommodates a substance, a stirring device that stirs the substance, and a bypass that causes the substance to circulate outside the vessel, in which one end and the other end of the bypass are connected to the vessel in a position at which the substance circulates in the bypass when the substance is stirred by the stirring device.

In the aspect, the reaction vessel may include a reaction vessel which is used in manufacturing of a chemical substance or a culturing vessel which is used in culturing of a biochemical substance.

According to the present invention, it is possible to continuously measure or observe a component, a state, or the like of the substance within the reaction vessel on the spot.

### BRIEF DESCRIPTION OF THE DRAWINGS

FIG. 1 is a diagram illustrating an example of a reaction vessel, which includes a stirring device and a bypass, according to Example 1 of the present invention.

FIGS. 2A to 2D are diagrams for describing a position of an end portion of the bypass which is connected to a vessel.

FIG. 3 is a diagram illustrating a result that is estimated by calculating a relationship between the position of the end portion of the bypass which is connected to the vessel and a flow velocity of a substance flowing into the bypass.

FIG. 4 is a diagram illustrating a relationship between a flow velocity of water circulating in the bypass and the number of rotation stirrings within the vessel, which is obtained from a result that is tested in the vessel experimentally made based on the present invention.

FIG. 5 is a diagram illustrating the relationship between the flow velocity of the water circulating in the bypass and the number of rotation stirrings within the vessel in a case where the vessel is a cylindrical body having a diameter of 1 m, which is obtained from a calculation result.

FIGS. 6A to 6E are diagrams illustrating a modification example of a shape of the bypass which is connected to the vessel.

FIG. 7 is a diagram illustrating an example of a configuration in which the bypass of the reaction vessel of the present invention is put into an optical analysis device and is analyzed.

FIG. 8 is a diagram illustrating an example of a reaction vessel according to Example 2 of the present invention.

FIG. 9 is a diagram illustrating an example of a reaction vessel according to Example 3 of the present invention.

FIG. 10 is a diagram illustrating an example of a reaction vessel according to Example 4 of the present invention.

FIG. 11 is a diagram illustrating an example of a reaction vessel according to Example 5 of the present invention.

FIGS. 12A to 12D are diagrams illustrating a plurality of examples of a bypass portion of the reaction vessel, which includes a configuration for the optical analysis device.

FIG. 13 is a diagram illustrating an example of a manufacturing system of a substance using a reaction vessel according to Example 6 of the present invention.

FIG. 14 is a diagram illustrating another example of the manufacturing system of a substance using a reaction vessel according to Example 6 of the present invention.

FIG. 15 is a flowchart illustrating an example of a manufacturing method of a substance using a reaction vessel according to Example 7 of the present invention.

### DETAILED DESCRIPTION OF THE INVENTION

Hereinafter, embodiments of the present invention will be described in detail based on the drawings. In all drawings for describing the embodiment, in principle, if the same sign is attached, the repeated description thereof will be omitted. As a direction on the description, a rectangular coordinate system including an X-axis, a Y-axis, and a Z-axis is used. The X-axis and the Y-axis are assumed to be directions configuring a horizontal plane, and the Z-axis is assumed to be a vertical direction.

### EXAMPLE 1

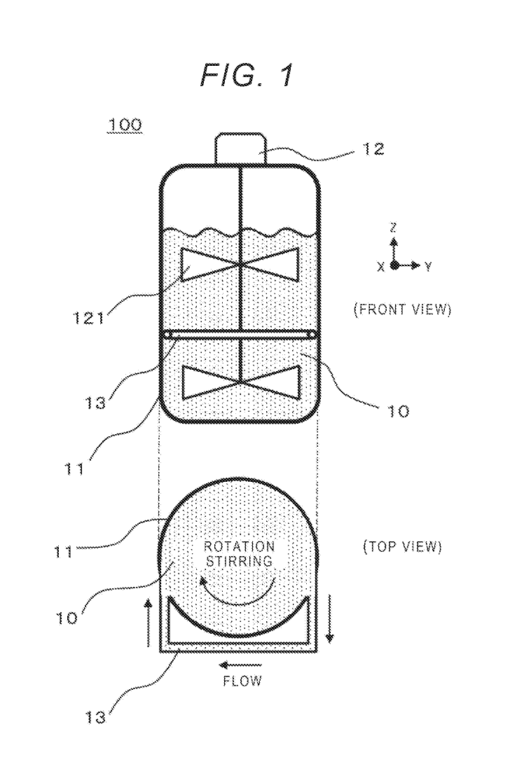

With reference to FIGS. 1 to 7, a reaction vessel, which includes a stirring device and a bypass, according to Example 1 of the present invention will be described.

FIG. 1 illustrates an example of a configuration of a reaction vessel 100 including the stirring device and the bypass according to Example 1.

The reaction vessel 100 is configured with a vessel 11 that accommodates a substance 10, a stirring device 12 that stirs the substance 10 and includes stirring blades 121, and a bypass 13 that causes the substance 10 to circulate outside the vessel 11. One end and the other end of the bypass 13 are connected to the vessel 11 in a position at which the substance 10 circulates in the bypass 13 when the substance 10 is stirred by the stirring device 12.

The stirring device 12 includes a rotation axis of the substantially vertical direction, and the substance 10 is rotationally stirred in a horizontal direction by the stirring device 12 and the stirring blades 121. Accordingly, the substance 10 circulates inside the bypass 13. A rotation direction of the stirring may be the reverse of that in FIG. 1, and in that case, a direction of a flow illustrated in FIG. 1 is reversed. The rotation direction may be reversed per time. Furthermore, the stirring device may perform rotation stirring, not by the stirring blades, but by a stirrer or a rotator using magnetic force and a rotating device. Alternatively, as long as the substance is rotationally stirred in the horizontal direction, other methods may be used. In order to rotationally stir the substance in the horizontal direction, it is desirable that the vessel is a cylindrical body, a conical body, or the like, and a horizontal cross section of the vessel has a circle shape or an oval shape.

Materials of the vessel 11 and the bypass 13 may be materials which are the same or materials which are different from each other. As a material, it is possible to use glass, stainless steel, polymer resin, or the like. The used material is desirable to be high in tolerance to a high temperature or a low temperature, pressure resistance, mechanical strength, chemical resistance, or tolerance to a sterilization method, and to be low in absorbency to gas, water or a chemical. The vessel 11 and the bypass 13 may have an integrated structure, or may have a detachable structure or a re-attachable structure by being separated from each other. In case of the integrated structure, the vessel 11 and the bypass 13 may be integrally molded, or may be attached by welding, adhesion, or the like. In case of the detachable structure or the re-attachable structure by being separated from each other, the vessel 11 and the bypass 13 may be structured by combining a flange and an O ring or a gasket, or may be structured by a screwed type.

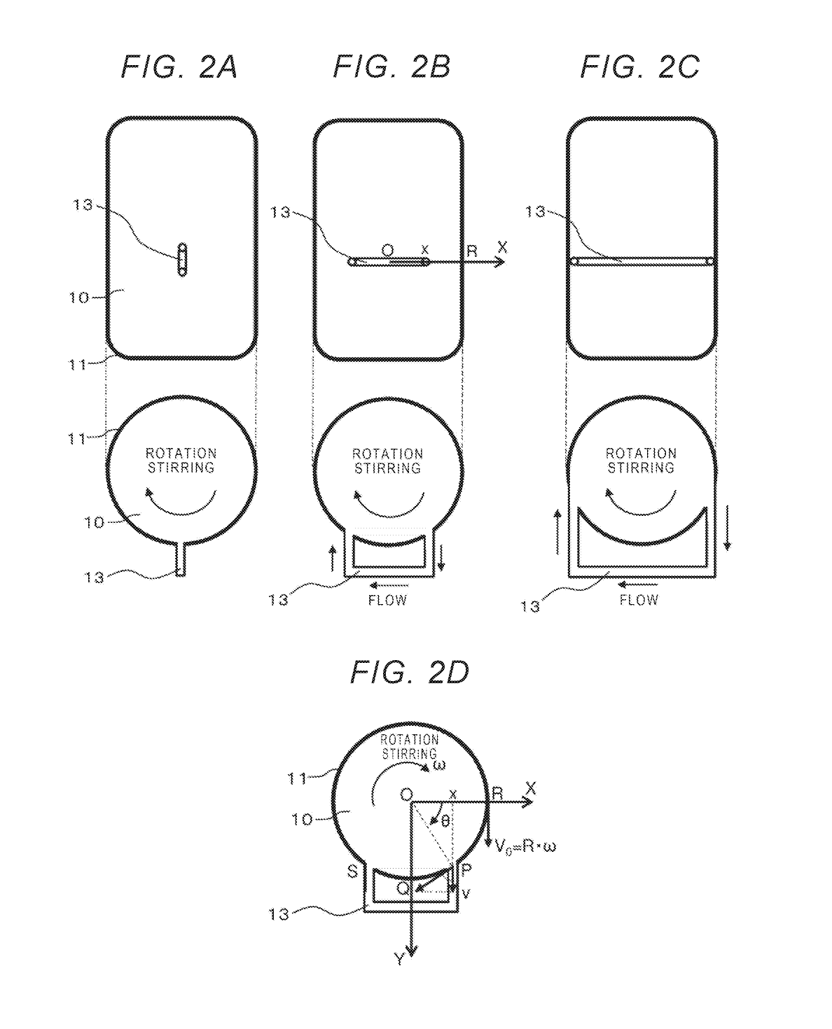

FIGS. 2A to 2D illustrate an example of the position of an end portion of the bypass 13 which is connected to the vessel 11. However, in order to easily view the drawings, the illustrations of the substance, the stirring device, and the stirring blades are omitted in FIGS. 2A to 2D. Here, as an example, a case where the vessel 11 is the cylindrical body (a radius is R) will be described.

As illustrated in FIG. 2D, when one end of the bypass 13 is assumed to be P, and the other end thereof is assumed to be S, XY coordinates of which the origin O is assumed to be a center of the rotation stirring are placed in the horizontal cross section of the vessel 11 including one end P and the other end S of the bypass 13. As one point of an inner circumferential circle on an inner wall surface of the vessel 11, one point thereof on the X-axis is assumed to be R. If an angle which is formed by a line segment OP and the X-axis (line segment OR) is assumed to be θ, θ becomes 0° when the point P overlaps with the point R, and θ adopts a value up to 90° when the point P increases in a direction toward the Y-axis, and the point P overlaps with the Y-axis (a point thereof is assumed to be a point Q). Here, in order to represent the position of the end portion of the bypass, if x is assumed to be the X coordinate of the point P, a case where x=R·cosθ is made. x adopts the value between 0 and R. The position of the end portion of the bypass 13 and the shape of the bypass 13 are illustrated in FIG. 2A when x=0, and are illustrated in FIG. 2C when x=R. FIG. 2B illustrates an example of a state between x=0 and x=R.

If an angular velocity of the rotation stirring is assumed to be ω, and the substance 10 within the vessel 11 is assumed to be circularly moved at the angular velocity ω, a velocity of the substance 10 in a tangential line direction of the inner circumferential circle at the point R becomes R·ω (the value is assumed to be V₀). At the point P when the angle is θ, a velocity v of the substance flowing into the bypass 13 becomes a case where v=V₀·cosθ=R·ω·cosθ=ω·x.

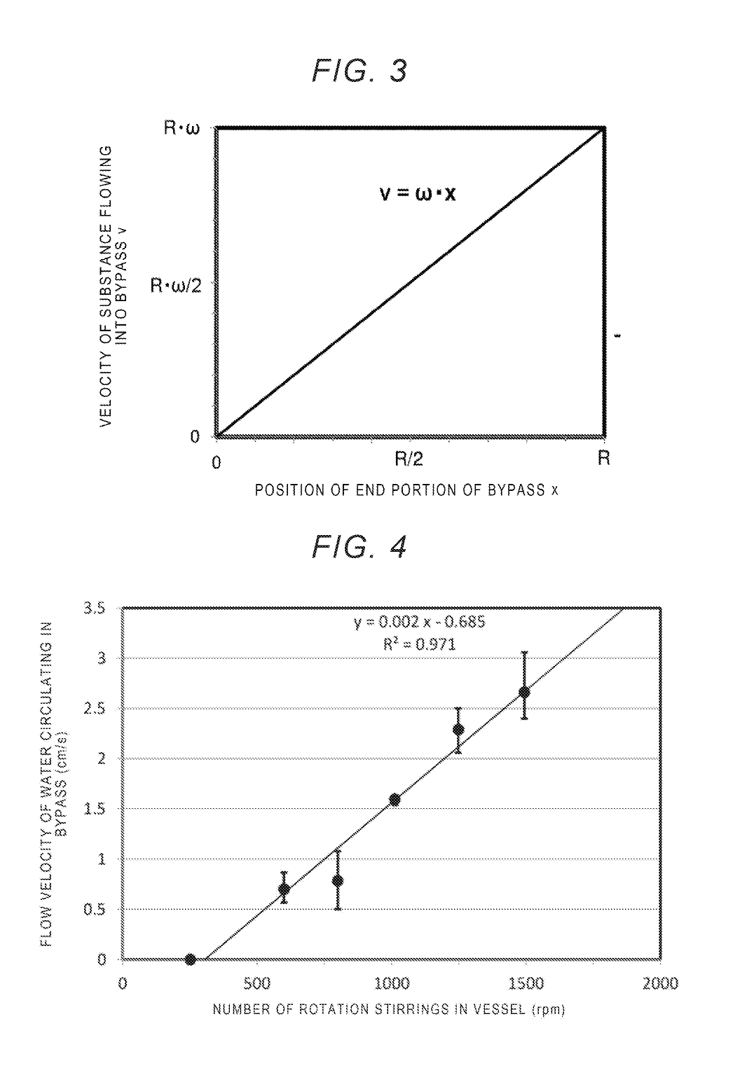

FIG. 3 illustrates a result that is estimated by calculating a relationship between the position of the end portion of the bypass which is connected to the vessel and a flow velocity of the substance flowing into the bypass. As illustrated in FIG. 3, when the value of x is changed from 0 to R, the value of the velocity v of the substance 10 flowing into the bypass 13 is changed from 0 to R·ω, and adopts the maximum value R·ω when x=R.

From the above description, when one end and the other end of the bypass 13 is connected to the vessel 11, in order to maximize the velocity of the substance 10 flowing into the bypass 13, it is desirable that one end and the other end of the bypass 13 are attached toward the direction of the tangential line of the inner circumferential circle on the inner wall surface of the vessel 11, as illustrated in FIG. 2C.

FIG. 4 illustrates a relationship between the flow velocity of water circulating in the bypass and the number of rotation stirrings within the vessel, which is obtained from a result that is tested in the vessel experimentally made based on Example 1.

The vessel 11 which is experimentally made has a configuration that is similar to that illustrated in FIG. 1. As a vessel 11, a cylindrical body which is made of a methacrylic resin, and has an outer diameter of 70 mm, an inner diameter of 60 mm, and a height of 150 mm is used. The water is used as a substance 10. However, the substance is rotationally stirred not by the stirring blades, but by the stirrer using the magnetic force and the rotating device. The shape of the stirrer is a disk shape which has a diameter of 30 mm. In a case where a rotating device in which the number of rotations is digitally displayed is used as a rotating device, and the substance 10 which is stirred within the vessel 11 is the water, a displayed value thereof is assumed to be equivalent to the number of rotations of the substance within the vessel.

As a bypass 13, a bypass obtained by connecting a glass tube to a flexible vinyl chloride tube is used. The flexible vinyl chloride tube is used for a connection portion of the vessel 11 and the bypass 13. The inner diameter of the glass tube is 5 mm, and a length thereof is 110 mm. The inner diameter of the flexible vinyl chloride tube is 3 mm, and a total length of a bypass portion is approximately 340 mm. The flow velocity of the water circulating in the bypass 13 is calculated from a movement distance per unit time of bubbles passing through the glass tube portion within the bypass 13. A volume of the bubbles which are used for the calculation is approximately 200 μL.

As illustrated in FIG. 4, a substantially linear relationship is obtained between the flow velocity of the water circulating in the bypass 13 and the number of rotation stirrings within the vessel 11. In a case where the number of rotation stirrings is 250 rpm or less, the flow velocity becomes 0, but this is not a case where the water within the bypass 13 is completely stopped because it is considered that if the flow velocity of the water circulating in the bypass 13 is small, an influence of friction resistance between the bubbles and the glass tube or adhesion force of the bubbles to the inner wall of the glass becomes large, thereby, the bubbles are not moved.

Next, in a case where the vessel 11 is scaled up, the flow velocity of the water circulating in the bypass 13 is estimated. By using the test result of the vessel illustrated in FIG. 4 which is experimentally made and the velocity in the tangential line direction of the inner circumferential circle on the inner wall surface of the vessel 11 which is circularly moved by the rotating stirring at that time, the flow velocity of the water circulating in the bypass 13 is calculated in a case where the vessel 11 is the cylindrical body which has the diameter of 1 m, as an example of the vessel having a practical size. From the number of rotation stirrings and the inner diameter of the vessel 11, the velocity in the tangential line direction of the inner circumferential circle on the inner wall surface of the vessel 11 is calculated in the circular movement of each number of rotations. In a case where only the diameter of the cylindrical body become large, and the configuration, the inner diameter, and the like of the bypass 13 in addition thereto are the same as those in the test of FIG. 4, physical parameters or properties are assumed not to be changed from as those in the test of FIG. 4. That is, it is assumed that there is a proportional relationship of FIG. 4 between the flow velocity of the water circulating in the bypass 13 and the number of rotation stirrings within the vessel 11, and the relationship is not changed even if the diameter of the vessel is changed.

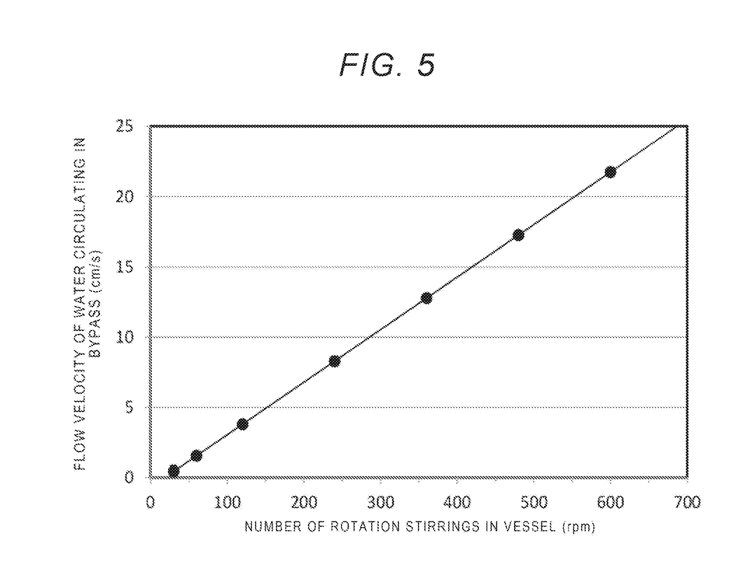

FIG. 5 illustrates the relationship between the flow velocity of the water circulating in the bypass 13 and the number of rotation stirrings within the vessel 11 in a case where the vessel 11 is the cylindrical body having the diameter of 1 m, which is obtained from the above calculation result. In a scope in which the above assumption is made, it is estimated that a correlation is made as illustrated in FIG. 5 in a case where the vessel is scaled up.

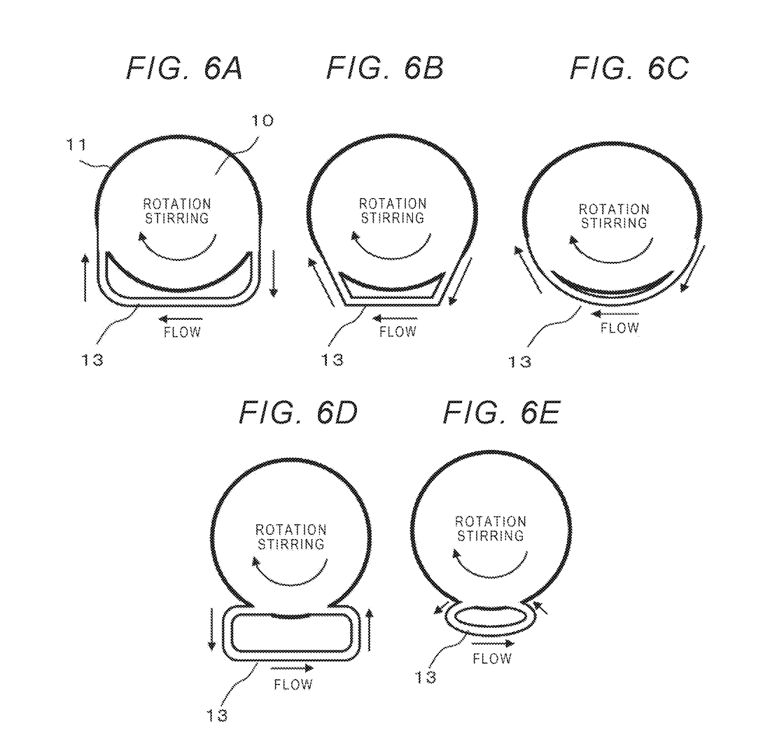

FIGS. 6A to 6E illustrate other examples of the shape of the bypass in the reaction vessel according to the present invention. However, in order to easily view the drawings, the illustration of the substance is omitted in FIGS. 6A to 6E.

In FIG. 1, a bent portion of the bypass 13 is formed into a right angle, but the bent portion may be formed into an arc shape in order to improve the flow of the substance 10 in the bent portion, as illustrated in FIG. 6A. In order to maximize the velocity of the substance flowing into the bypass 13, since it is desirable that one end and the other end of the bypass are attached toward the direction of the tangential line of the inner circumferential circle on the inner wall surface of the vessel 11, in consideration thereof, cases of FIGS. 6B, 6C, 6D, and 6E are made.

In FIG. 6B, connection positions of one end and the other end of the bypass 13 to the vessel 11 are made be close, thereby, it is possible to make the length of the bypass 13 be shorter than that in FIG. 1 or FIG. 6A. In FIG. 6C, since the whole of the bypass 13 is made into the arc shape, thereby, there is no angular bending, it is possible to make the flow of the substance 10 be smoother than ever. In FIG. 6D, since the bypass 13 has a substantially rectangular shape, and the connection position to the vessel is disposed on one side of the rectangular shape, it is possible to make the connection positions of the end portion of the bypass 13 to the vessel 11 be close to each other. Ina case where a plurality of bypasses 13 are disposed, the bypasses are less likely to interfere with each other, and the disposition thereof becomes easy. In FIG. 6E, the whole of the bypass 13 is made into the oval shape, thereby, it is possible to make the length of the bypass 13 be shorter than that in FIG. 6D, and it is possible to make the flow of the substance 10 be smoother than ever. The bent shape of the bypass 13 is not limited to the oval shape illustrated in FIG. 6E, but may be the circle shape.

The rotation direction of the stirring may be the reverse of those in FIGS. 6A to 6E, and in this case, the directions of the flows illustrated in FIGS. 6A to 6E are reversed. In a case where the flow velocity of the substance 10 circulating in the bypass 13 may be not necessarily the maximum, the bypass 13 may be inclined from the direction of the tangential line of the inner circumferential circle, and may be connected to the vessel 11, as illustrated in FIG. 2B.

Bases on the relationship of mounting between the vessel 11 and the bypass 13, or for the convenience of measurement or observation by using the bypass 13, if necessary, the length of the bypass 13 may be made longer than that illustrated in the present invention, or may be guided into a curved shape, and the shape of the bypass 13 may be changed.

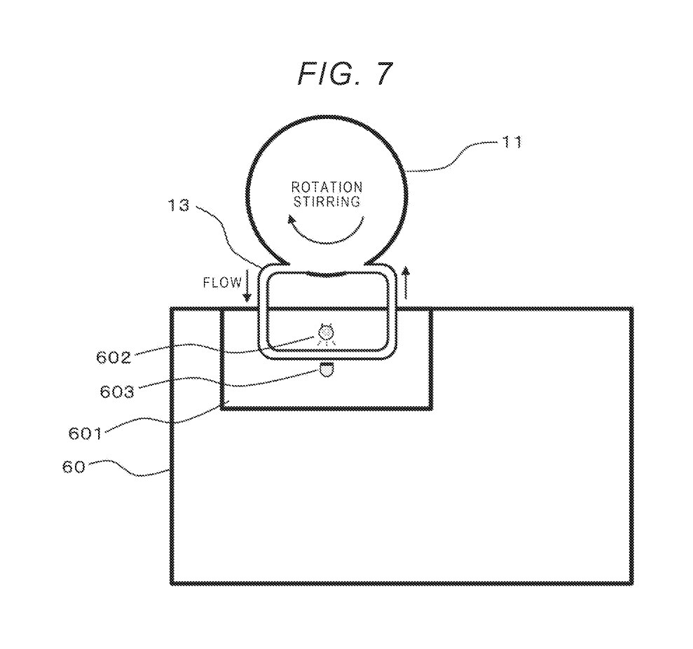

FIG. 7 illustrates an example of a configuration in which an analysis is performed by an optical analysis device, by using the reaction vessel according to Example 1.

An optical analysis device 60 is a device which is independent from the reaction vessel 100. For the optical analysis, the reaction vessel 100 is transported to a place of the optical analysis device 60, and is disposed such that the bypass 13 is put into an analysis chamber 601 of the optical analysis device 60. An analysis area of the bypass 13 is set between a light source 602 and a light-receiving portion 603 of the optical analysis device 60, and the optical analysis is performed by irradiating the analysis area of the bypass 13 with the light. In order to shield the light, the whole of the reaction vessel 100 may be put into the analysis chamber 601.

The optical analysis device 60 may be a handy type device having portability, or may be pressed against the analysis area of the bypass 13 by being caused to approach the analysis area of the bypass 13.

In FIG. 7, the reaction vessel of FIG. 6D is described as a reaction vessel, but other reaction vessels of FIG. 1 and FIGS. 6A, 6B, 6C, and 6E may be used.

According to Example 1, there are the following effects.

It is possible to continuously measure or observe a component, a state, or the like of the substance within the reaction vessel on the spot.

Since there is no need to open the reaction vessel or put in and out a sampling tool for sampling or analysis, it is possible to prevent a component change within the reaction vessel due to a case where gas is released outside or air is mixed inside, and it is possible to prevent a case where dirt or bacteria is mixed and contaminated from the outside.

Since there is no need to dispose a mechanical movable portion such as a sampling pump, a sampling cylinder, or a circulation pump of the bypass in the reaction vessel, it is possible to simplify the structure, and it is possible to reduce a risk of failure.

### EXAMPLE 2

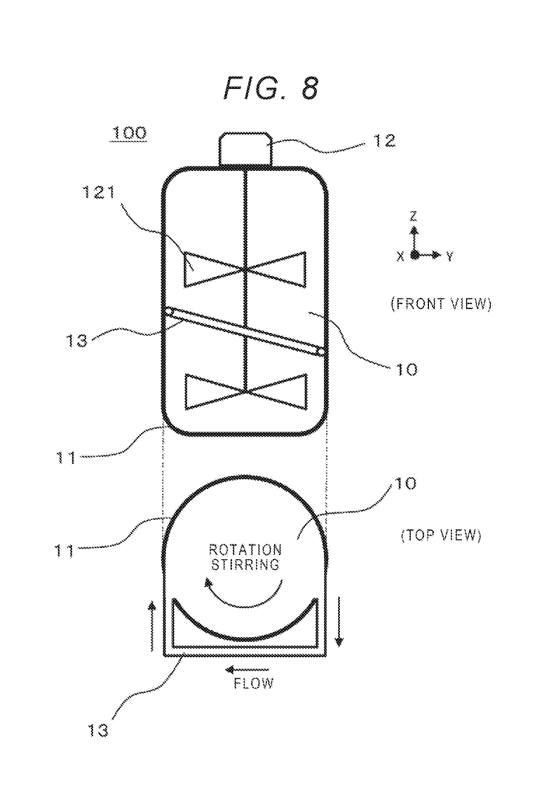

FIG. 8 illustrates an example of a reaction vessel according to Example 2 of the present invention. However, in order to easily view the drawing, the illustration of the substance is omitted in FIG. 8.

In FIG. 1, the stirring blades 121 rotate in the horizontal direction, and one end and the other end of the bypass 13 are horizontally disposed, and are connected to the vessel 11 such that one end and the other end of the bypass 13 are horizontal to the vessel 11.

On the contrary, in FIG. 8, one end of the bypass 13 is disposed to be higher than the other end of the bypass 13. It is desirable that the bubbles entering the bypass 13 flow out to the inside of the vessel 11 without staying in the bypass 13. Therefore, when a portion flowing into the bypass 13 from the inside of the vessel 11 is defined as an inlet of the bypass 13, and a portion flowing out to the inside of the vessel 11 from the inside of the bypass 13 is defined as an outlet of the bypass 13, the end portion of the bypass 13 which is equivalent to the outlet of the bypass 13 is disposed to be higher than the end portion of the bypass 13 which is equivalent to the inlet of the bypass 13.

According to Example 2, one end of the bypass is disposed to be higher than the other end, thereby, it is possible to prevent the bubbles irrupting a bypass flow path from staying.

### EXAMPLE 3

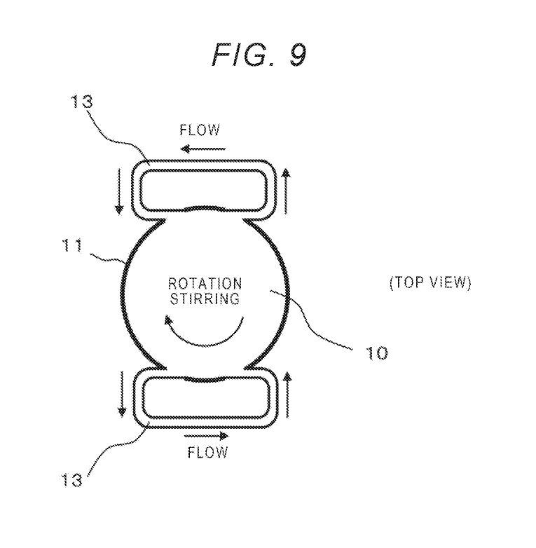

FIG. 9 illustrates an example of a reaction vessel according to Example 3 of the present invention. However, in order to easily view the drawing, the illustration of the substance is omitted in FIG. 9.

In FIG. 9, two bypasses 13 are disposed on a circumference of the vessel 11 such that two bypasses 13 face each other. The plurality of bypasses 13 are disposed in the vessel 11, thereby, it is possible to make one thereof as a backup of the bypass, and it is possible to carry out the measurements or the observations several time by each bypass. The plurality of bypasses 13 may be formed into the shapes which are the same, or into the shapes which are different from each other. Not only two bypasses may be disposed as illustrated in FIG. 9, but also three or more bypasses may be disposed.

According to Example 3, the plurality of bypasses are disposed, thereby, it is possible to mount a plurality of analysis devices of which functions are different from each other, or when one bypass becomes unusable, it is possible to substitute other bypasses for the unusable bypass.

### EXAMPLE 4

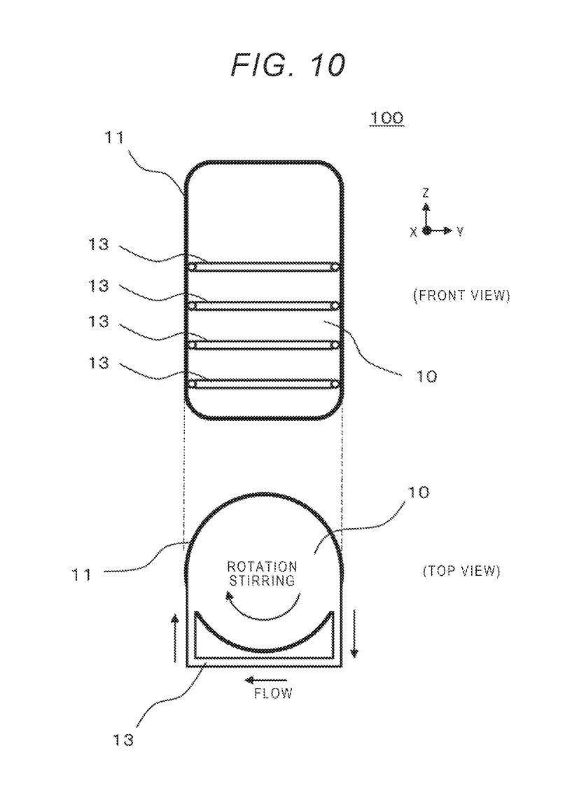

FIG. 10 illustrates an example of a reaction vessel according to Example 4 of the present invention. However, in order to easily view the drawing, the illustrations of the substance, the stirring device, and the stirring blades are omitted in FIG. 10.

In Example 4, the plurality of bypasses 13 are disposed in a depth direction (or a height direction) of the vessel 11. The shapes of the bypasses may be all the same, or may be different from each other. The positions of the bypasses may be disposed at equal intervals in the depth direction (or the height direction), or may be disposed at different intervals. As illustrated in FIG. 9 according to Example 3, the plurality of bypasses may be disposed in a circumferential direction of the vessel, or as illustrated in FIG. 10, the plurality of bypasses may be disposed in the depth direction (or the height direction) of the vessel 11. Alternatively, as illustrated in FIG. 8 according to Example 2, one end of the bypass 13 may be disposed to be higher than the other end of the bypass 13, or as illustrated in FIG. 10, the plurality of bypasses may be disposed in the depth direction (or the height direction) of the vessel 11. The measurement or the observation is carried out by each bypass 13, thereby, it is possible to check out distribution of the substance 10 in the depth direction (or the height direction) within the vessel 11.

According to Example 4, the plurality of bypasses are disposed, thereby, it is possible to measure concentration distribution or the like depending on the position.

### EXAMPLE 5

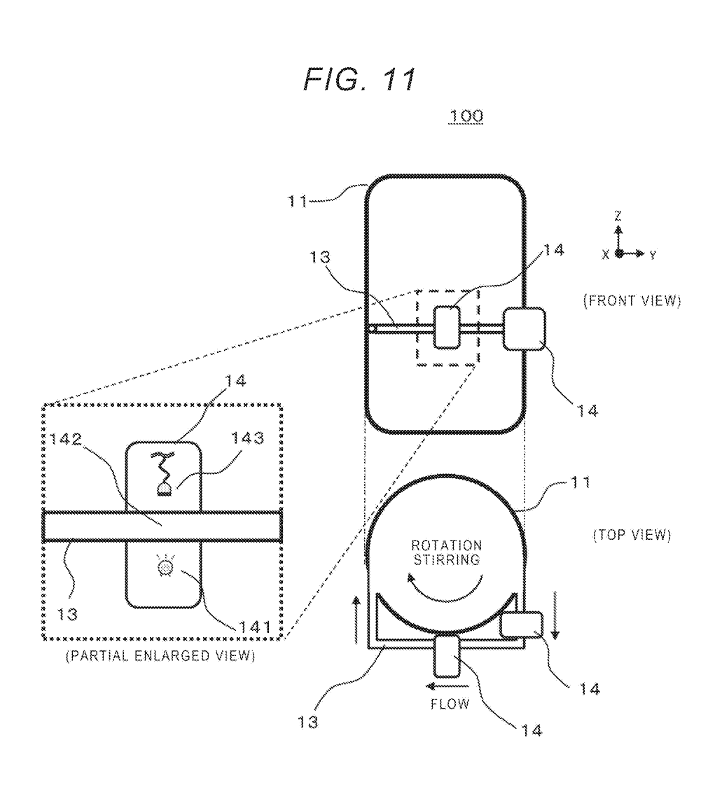

FIG. 11 illustrates an example of a reaction vessel according to Example 5 of the present invention. However, in order to easily view the drawing, the illustrations of the substance, the stirring device, and the stirring blades are omitted in FIG. 11.

In Example 5, an optical analysis device 14 is integrated with the reaction vessel 100 by being attached to the reaction vessel 100. As illustrated in FIG. 11, the optical analysis device 14 is attached to the bypass 13 of the vessel 11, and is integrated with the reaction vessel. In the optical analysis device 14, a transparent portion 142 is disposed in the bypass 13, a light source 141 and a light-receiving portion 143 are attached to the transparent portion such the transparent portion is irradiated with the light, and the optical analysis is performed. The transparent portion 142 has permeability with respect to the light which is emitted from the light source 141 and the light to be measured by the light-receiving portion 143. The optical analysis device 14 includes a spectroscopic analysis device using an infrared ray, a near infrared ray, a visible ray, an ultraviolet ray, a fluorescent ray or an X-ray. The material of the bypass portion may be any which is suitable for the optical analysis device having the permeability with respect to each light. For example, quartz glass or the like is used for the transparent portion 142 between the light source 141 and the light-receiving portion 143.

When the portion flowing into the bypass 13 from the inside of the vessel 11 is assumed to be the inlet of the bypass 13, as illustrated in FIG. 11, the optical analysis device 14 is disposed in the vicinity of the inlet of the bypass 13, thereby, it is possible to measure the state of the substance which is close thereto in accordance to the state of the vessel 11. One optical analysis device 14 may be disposed in one bypass 13, or a plurality of optical analysis devices 14 may be disposed in one bypass 13. If the plurality of bypasses 13 are disposed, the plurality of optical analysis devices 14 may be disposed one by one in one bypass 13, or the plurality of optical analysis devices 14 may be disposed in one bypass 13.

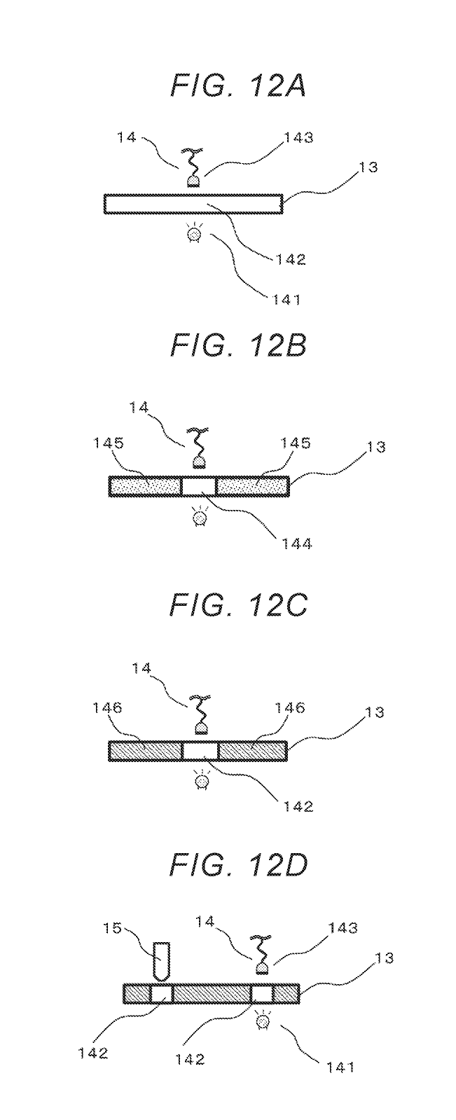

FIGS. 12A to 12D illustrate a plurality of examples of the bypass portion of the reaction vessel, which includes a configuration for the optical analysis device. In order to easily view the drawing, the illustration of the connection portion between the bypass and the vessel is omitted.

In FIG. 12A, all portions of the bypass 13 become transparent. As a material, glass, a polymeric resin or the like is used. As a polymeric resin, a polystyrene resin, a methacrylic resin, a polycarbonate resin, an acrylonitrile·butadiene·styrene copolymer resin, a cycloolefin polymer resin, a copolymer thereof, or a copolymer thereof with other monomers may be used. In a case where the light source of the optical analysis device is the X-ray, thin aluminum, a polyethylene resin, or a fluorocarbon resin may be used. In any case, it is desirable that the material is not dissolved in the substance accommodated in the vessel 11, does not absorb the substance, or is not corroded and degraded. Regarding the used temperature, it is desirable that the material has temperature tolerance so as not to be softened or melted.

In FIG. 12B, the materials which are different from each other are combined for the portion of the bypass 13. In particular, a material A144 is disposed between the light source 141 and the light-receiving portion 143, and a material B145 which is separated from the material A144 is disposed in other portions. It is possible to connect the materials which are different from each other by various methods such as pressure joining, welding, and adhesion.

In FIG. 12C, a space between the light source 141 and the light-receiving portion 143 is made into the transparent portion 142, and the light is shielded by a light-shielding portion 146 in other portions. In the light-shielding portion 146, the light may be shielded by a material which is the same as the material of the bypass 13, or a material that is capable of shielding the light may be separately attached to the outside or the inside of the bypass 13. As an example of the light-shielding portion, the bypass portion may be formed of stainless steel, or the outside of the bypass may be covered with stainless steel, aluminum, steel or aluminum onto which a blackening treatment is performed, or black paper or cloth.

In FIG. 12D, the optical analysis device 14 which is configured from the light source 141 and the light-receiving portion 143, and an optical observation device 15 such as a microscope are attached to the transparent portion 142 of the bypass 13. The optical analysis device 14 which is configured from the light source 141 and the light-receiving portion 143 is not attached, and only the optical observation device 15 such as the microscope may be attached. The optical observation device 15 such as the microscope may be a camera or an imaging element, or a suitable light source may be combined therewith. In a case where the substance is a liquid, it is possible to perform counting of solid contents such as fine particles and cells in the liquid, shape observation, imaging of a photograph, and the like. The optical observation device 15 such as the microscope is not attached, and two of the optical analysis devices 14 which are configured from the light source 141 and the light-receiving portion 143 may be attached.

According to Example 5, since the optical analysis device is integrated with the reaction vessel by being attached to the reaction vessel, there is no need to dispose the reaction vessel in the optical analysis device whenever the measurement is performed, thereby, it is possible to perform the measurement in a short time.

### EXAMPLE 6

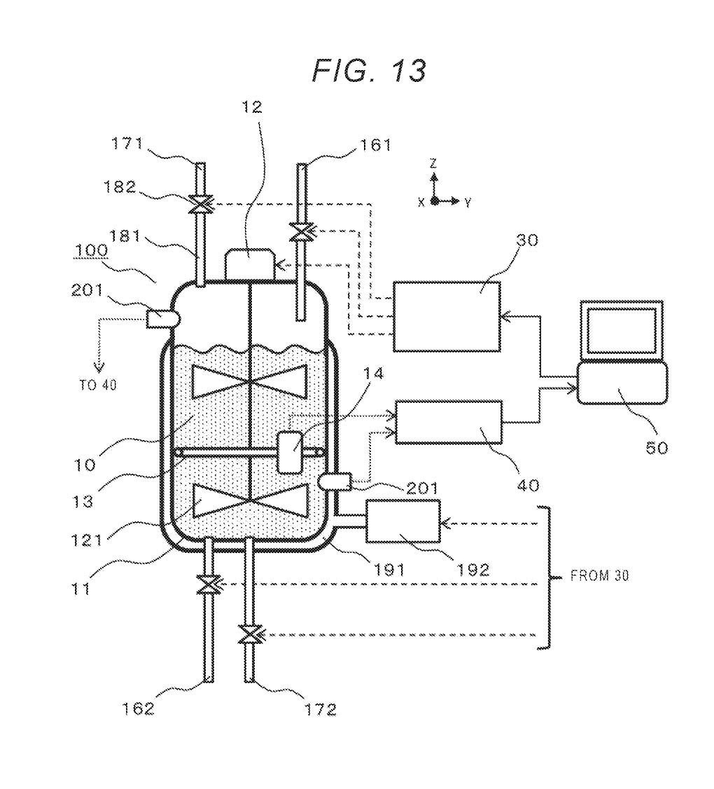

FIG. 13 illustrates a case where the stirring blades are used, as an example of a manufacturing system of the substance using a reaction vessel according to Example 6 of the present invention.

The reaction vessel 100 is illustrated in FIG. 11 of Example 5, and includes the stirring device 12 and the stirring blades 121 that stir the substance 10, in the vessel 11, and the bypass 13 that causes the substance 10 to circulate outside the vessel 11. The bypass 13 includes the optical analysis device 14 or the optical observation device 15 (not illustrated).

The manufacturing system of the substance using the reaction vessel according to Example 6 includes the reaction vessel 100 described above, a substance supply portion 161, a gas introduction or pullout portion 171, a substance pullout portion 162, and a gas introduction portion 172. The substance supply portion 161, the gas introduction or pullout portion 171, the substance pullout portion 162, and the gas introduction portion 172 are respectively configured with a plumbing 181 and a valve 182.

A constant temperature oven 191 is included on an outer circumference of the reaction vessel 100, and is connected to a temperature adjusting device 192. Various sensors 201 are attached to the vessel 11. By the sensors, the temperature, pressure, a gas concentration, a component concentration of the substance 10, a pH, specific weight, a color, turbidity, electric conductivity, and the like within the vessel 11 are measured. For example, in a case where the substance 10 is the gas and the liquid, the temperature, the gas concentration, the component concentration of the substance 10, and the like in both of the gas and the liquid are measured.

The stirring device 12, the valve 182, and the temperature adjusting device 192 are connected to a control device 30. The sensor 201, the optical analysis device 14, or the optical observation device 15 is connected to a measurement device 40.

Since the measurement device 40 is connected to an analyzing device 50 such as a personal computer, measurement data or observation data is sent to the analyzing device 50, and a control instruction for measurement or observation is received from the analyzing device 50. Since the analyzing device 50 is connected to the control device 30, the control instruction is sent, based on a program or the analyzed result. The control device 30 receives the control instruction from the analyzing device 50, and performs the control of the stirring device 12, various valves 182, the temperature adjusting device 192, or the like.

Not only one device or piece described above, but also a plurality of devices or pieces may be attached. In addition to the device or the piece which is used herein, it is possible to add the devices or the pieces which are necessary for the manufacturing of the chemical substance or the culturing of the biochemical substance. In a case where the light is necessary, there is a light source for light irradiation, or the like. There is a case where the temperature is controlled by putting an electrothermal heater, or the plumbing through which vapor or a refrigerant passes into the vessel, in replacement of attaching the constant temperature oven on the outer circumference of the vessel.

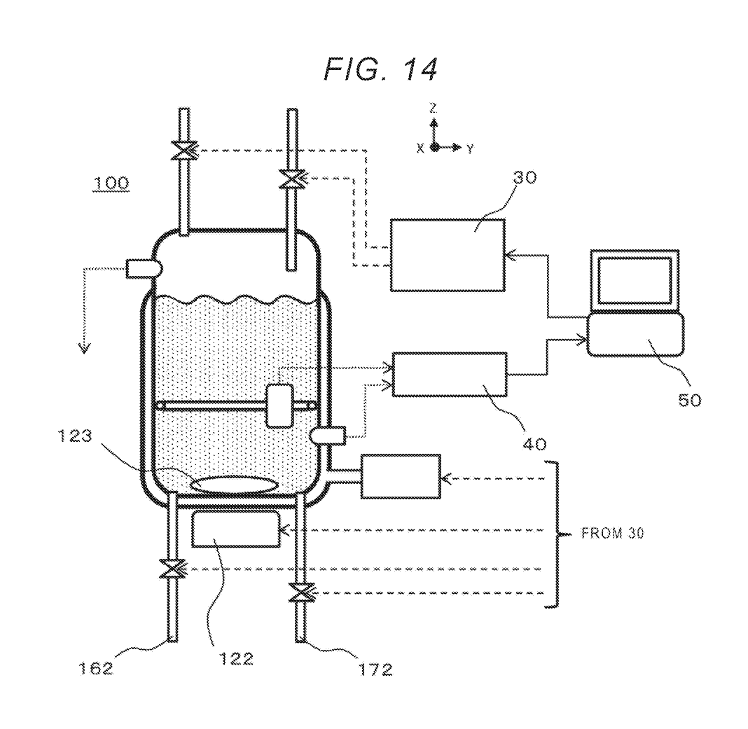

FIG. 14 illustrates a case where the stirrer is used, as another example of the manufacturing system of the substance using the reaction vessel of the present invention. In replacement of the stirring device 12 and the stirring blades 121 illustrated in FIG. 13, here, a rotating device 122 and a stirrer 123 which use the magnetic force are attached. Due to a rotating magnetic field which is generated by the rotating device 122, the stirrer 123 of a magnetic body rotates. The rotating device 122 is connected to the control device 30. In addition thereto, the configurations are the same as those of FIGS. 12A to 12D.

In the examples illustrated in FIGS. 13 and 14, the optical analysis device 14 is configured to be integrated with the reaction vessel 100, but as illustrated in FIG. 7, the optical analysis device 14 may be configured to be separated from the reaction vessel 100, or may be combined when the reaction vessel is attached thereto.

According to the manufacturing system of the substance in Example 6, it is possible to manufacture the substance while continuously measuring or observing the component, the state, or the like of the substance within the reaction vessel on the spot.

### EXAMPLE 7

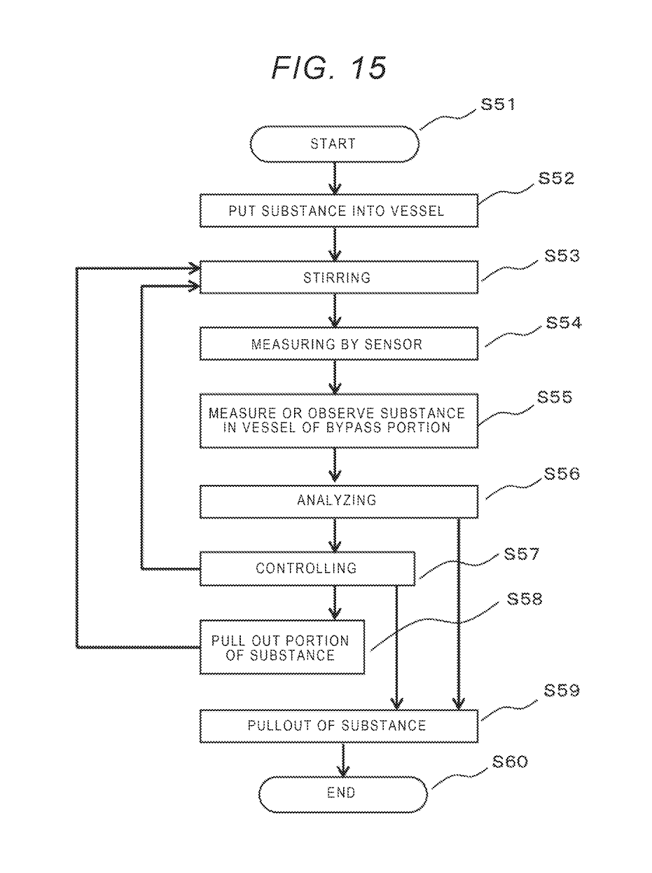

FIG. 15 illustrates an example of a flowchart of a manufacturing method of a substance using the reaction vessel according to Example 7 of the present invention.

In Example 7, a feature thereof is that the substance within the reaction vessel is measured or observed by the bypass portion which is included in the reaction vessel, the result thereof is analyzed, and the substance is manufactured while various devices attached to the reaction vessel are controlled, based on the analyzed result. Here, a case where the substance is the liquid will be described.

As illustrated in FIG. 15, in step 51, first, the substance is put into the reaction vessel. If the substance which is put into the reaction vessel is a chemical substance that is manufactured by a chemical reaction, there is a raw material, a catalyst, a solvent, or the like. If the substance which is put into the reaction vessel is a biochemical substance that is manufactured by culturing, there is a culture medium including nutrients and cells or fungi.

Subsequently, in step 53, the substance is stirred. Before or after the stirring, a temperature, pressure, or the like may be adjusted, or other substances may be supplied. In accordance with the instruction from the analyzing device, in step 54, the measurement by the sensor is carried out, and in step 55, the measurement or the observation of the substance within the vessel in the bypass portion is carried out.

In the measurement by the sensor, the temperature, the pressure, the gas concentration, the component concentration of the substance, the pH, the specific weight, the color, the turbidity, the electric conductivity, and the like within the reaction vessel are measured.

On the other hand, in the measurement or the observation of the substance within the reaction vessel in the bypass portion, identification of the substance, the component concentration measurement of the substance, and the like are carried out, by using the optical analysis device. Alternatively, the counting of the solid contents such as the fine particles and the cells in the liquid, the shape observation, the imaging of the photograph, and the like are carried out, by using the optical observation device.

In step 56, the results of the measurement and the observation are analyzed by the analyzing device, and in step 57, the control is carried out by the control device based on the analyzed result or the program. Accordingly, the temperature, the pressure, the number of rotation stirrings, the gas concentration, the component concentrations of the substance, and the like are adjusted such that the reaction or the culturing becomes suitable.

Thereafter, the stirring is continued, and the measurement and the observation are repeated in accordance with the instruction from the analyzing device. The stirring may be continued, or may be intermittent, and the number of rotations or the rotation direction may be changed. The stirring may be continued, or may be stopped in the middle of the measurement and the observation.

Based on the analyzed result by the analyzing device, the reaction or the culturing may be continued as it is without pulling out a portion of the substance from the vessel, or as illustrated in step 58, a portion of the substance may be pulled out from the vessel.

In step 59, the reaction or the culturing is completed or stopped, thereby, all of the substances are pulled out.

A continuous treatment may be used while a portion of the substance is pulled out from the vessel or the substance may be supplied to the vessel in the middle thereof, or a batch treatment which is pulled out after a predetermined reaction or culturing is completed may be used. By the above configuration, it is possible to provide the manufacturing method of the substance such as the chemical substance or the biochemical substance.

Hitherto, the invention made by the present inventors is specifically described based on the embodiments, but the present invention is not limited to each example described above, and may be variously modified in the scope without departing from the gist thereof, needless to say.

For example, each example is a case where the present invention is described in detail in order to easily understand the present invention, and is not necessarily limited to a case where all of the described configurations are included.

It is possible to replace a portion of the configuration of a certain example with the configurations of other examples, or it is possible to add the configurations of other examples to the configuration of a certain example. Regarding a portion of the configuration of each example, it is possible to add, delete, or replace other configurations.

For example, in Example 7, since the substance which is put into the reaction vessel is a substance of a gas state, a liquid state, or a solid state having fluidity, there are various substances such as a chemical product, the medicine, and the raw material of food. It is possible to perform the application not only to a transparent liquid but also to a suspension liquid including fine particles or an emulsion including oil droplets. It is possible to change the shapes or the sizes of the vessel, the bypass, the stirring blades, and the stirrer.

As a reaction vessel of the present invention, it is used for the reaction vessel that is used in the manufacturing of various substances, such as a reaction vessel which is used for the manufacturing the chemical substance, or a culturing vessel which is used for the culturing of the biochemical substance such as the medicine.

What is claimed is:

1. A reaction vessel comprising:
a vessel that accommodates a substance;
a stirring device that stirs the substance; and
a bypass that causes the substance to circulate outside the vessel,
wherein one end and the other end of the bypass are connected to the vessel in a position at which the substance circulates in the bypass when the substance is stirred by the stirring device.

2. The reaction vessel according to claim 1,
wherein the bypass includes an area for optical analysis or optical observation.

3. The reaction vessel according to claim 1,
wherein one end and the other end of the bypass are attached toward a direction of a tangential line of an inner circumferential circle on an inner wall surface of the vessel.

4. The reaction vessel according to claim 1,
wherein the stirring device rotates in a horizontal direction, and
one end and the other end of the bypass are horizontally disposed.

5. The reaction vessel according to claim 1,
wherein the stirring device rotates in a horizontal direction, and
the other end of the bypass which is an outlet of the substance is disposed to be higher than one end of the bypass which is an inlet of the substance.

6. The reaction vessel according to claim 1, further comprising:
a plurality of bypasses.

7. The reaction vessel according to claim 6,
wherein the plurality of bypasses are disposed in a height direction of the vessel.

8. The reaction vessel according to claim 6,
wherein the plurality of bypasses are disposed in a circumferential direction of the vessel.

9. The reaction vessel according to claim 2,
wherein an optical analysis device or an optical observation device is attached to the area for optical analysis or optical observation of the bypass.

10. A manufacturing system of a substance using a reaction vessel, the system comprising:
a reaction vessel; and
a device that performs optical analysis or optical observation,
wherein the reaction vessel includes a vessel that accommodates a substance, a stirring device that stirs the substance, and a bypass that causes the substance to circulate outside the vessel,
one end and the other end of the bypass are connected to the vessel in a position at which the substance circulates in the bypass when the substance is stirred by the stirring device, and
the bypass of the reaction vessel is disposed in a position at which the device that performs the optical analysis or the optical observation is capable of performing the optical analysis or the optical observation.

11. The manufacturing system of a substance using a reaction vessel according to claim 10,
wherein the bypass of the reaction vessel includes an area for optical analysis or optical observation.

12. The manufacturing system of a substance using a reaction vessel according to claim 10,
wherein the reaction vessel is a reaction vessel which is used in manufacturing of a chemical substance.

13. The manufacturing system of a substance using a reaction vessel according to claim 10,
wherein the reaction vessel is a culturing vessel which is used in culturing of a biochemical substance.

14. A manufacturing method of a substance using a reaction vessel, which is used in a manufacturing system including a reaction vessel and a device that performs optical analysis or optical observation, in which the reaction vessel includes a vessel that accommodates a substance, a stirring device that stirs the substance, and a bypass that causes the substance to circulate outside the vessel, and one end and the other end of the bypass are connected to the vessel in a position at which the substance circulates in the bypass when the substance is stirred by the stirring device, the method comprising:
circulating the substance in the bypass by performing rotation stirring by the stirring device;
analyzing or observing the substance of the bypass of the reaction vessel by the device that performs the optical analysis or the optical observation; and
controlling the manufacturing system based on a result of the analyzing or the observing.
